(19) United States
(12) Patent Application Publication
(10) Pub. No.: US 2025/0323416 A1
(43) Pub. Date: Oct. 16, 2025

(54) LOWBAND DIPOLE WITH IMPROVED GAIN AND ISOLATION

(71) Applicant: John Mezzalingua Associates, LLC, Liverpool, NY (US)

(72) Inventors: Niranjan Sundararajan, Clay, NY (US); Wengang Chen, Jamesville, NY (US); Jiaqiang Zhu, Baldwinsville, NY (US)

(21) Appl. No.: 19/004,931

(22) Filed: Dec. 30, 2024

Related U.S. Application Data
(63) Continuation of application No. 18/101,332, filed on Jan. 25, 2023, now Pat. No. 12,191,580.
(60) Provisional application No. 63/303,085, filed on Jan. 26, 2022.

(51) Int. Cl. H01Q 5/42; H01Q 1/24; H01Q 1/52; H01Q 21/26

(52) U.S. Cl. CPC H01Q 5/42; H01Q 1/246; H01Q 1/521; H01Q 21/26

(57) ABSTRACT

A lowband radiator has four dipole arms and a central region that is centered at the intersection of the dipole arms. Each of the dipole arms has a sequence of capacitive and inductive structures and a pair of high gain wings that are disposed in the dipole central region. In one embodiment of the lowband radiator, each dipole arm has a gap within the central region that is colinear with the dipole arm. The dipoles provide for improved isolation from nearby midband radiators while providing high gain.

### BACKGROUND OF THE INVENTION

This application is continuation of U.S. patent application Ser. No. 18/101,332, filed Jan. 25, 2023, which is a non-provisional of and claims priority to Provisional Patent Application Ser. No. 63/303,085, filed Jan. 26, 2022, which applications are hereby incorporated by this reference in their entireties as if fully set forth herein.

### FIELD OF THE INVENTION

The present invention relates to wireless communications, and more particularly, to multiband cellular antennas.

### RELATED ART

Modern cellular communication is seeing the incorporation of new frequency bands to enable increased data rates and new services to customers. Examples include the incorporation of C-Band (3.4-4.2 GHz) and CBRS (Citizen Broadband Radio Service, 3.7-4.2 GHz), which are being added to legacy bands lowband (617-8904 MHZ) and midband (1695-2690 MHz).

The incorporation of new frequency bands presents a challenge to antenna designers in that there is significant resistance to increasing the size of cellular antennas to accommodate radiators designed to operate in the new frequency bands. For example, increasing the size of a cellular antenna worsens its wind loading, which may lead to significant problems for antennas that are mounted on top of cell towers. Accordingly, mobile network operators are reluctant to increase the size of their antennas. This puts considerable pressure on antenna designers to design antenna radiators and radiator configurations for lowband, midband, and C-Band, or CBRS that can be packed into existing antenna form factors while not suffering from interference between frequency bands. This interference can degrade the performance of the antenna radiators by, for example, corrupting the antenna gain pattern.

Lowband radiators are particularly problematic in that they are the largest structures within a multiband antenna and are thus the most susceptible to causing interference with the other bands. Conventional solutions, such as antenna cloaking, may be employed in the design of lowband dipoles to mitigate interference from the midband (for example), but these conventional solutions typically decrease the gain of the lowband dipoles themselves.

Accordingly, what is needed is a lowband dipole design that provides for effective cloaking without sacrificing gain.

### SUMMARY OF THE DISCLOSURE

An aspect of the present disclosure involves a dipole for a multiband antenna. The dipole comprises four dipole arms arranged in a cross pattern, wherein the four dipole arms has a first pair of dipole arms that are colinear and configured to radiate a first RF (Radio Frequency) signal at a first polarization angle and a second pair of dipole arms that are colinear and configured to radiate a second RF signal at a second polarization angle, wherein the first polarization angle is perpendicular to the second polarization angle; and a central region, wherein the central region is centered at an intersection of the first pair of dipole arms and the second pair of dipole arms, wherein each of the dipole arms comprises a sequence of capacitive structures and inductive structures and a pair of high gain wings, wherein the pair of high gain wings are disposed in the central region.

Another aspect of the present disclosure involves a multiband antenna. The multiband antenna comprises a plurality of midband dipoles arranged in a plurity of unit cells, wherein the plurality of unit cells are arranged in columns; and a plurality of lowband dipoles, wherein each of the plurality of lowband dipoles is disposed within a corresponding unit cell, wherein each of the lowband dipoles has four dipole arms arranged in a cross pattern, wherein the four dipole arms are arranged in a first pair of dipole arms and a second pair of dipole arms, the first pair of dipole arms are colinear and configured to radiate a first RF (Radio Frequency) signal at a first polarization angle and the second pair of dipole arms are colinear and configured to radiate a second RF signal at a second polarization angle, wherein the first polarization angle is perpendicular to the second polarization angle, wherein each of the lowband radiators has a central region, wherein the central region is centered at an intersection of the first pair of dipole arms and the second pair of dipole arms, wherein each of the dipole arms comprises a sequence of capacitive structures and inductive structures and a pair of high gain wings, wherein the pair of high gain wings are disposed in the central region, wherein each of the dipole arms has an outer arm that overlaps a corresponding midband dipole.

### BRIEF DESCRIPTION OF THE DRAWINGS

FIG. 1A illustrates an exemplary multiband antenna array face incorporating a lowband dipole of a first embodiment according to the disclosure.

FIG. 1B illustrates a single unit cell within the antenna of FIG. 1A.

FIG. 1C illustrates an exemplary lowband dipole according to a first embodiment of the disclosure.

FIG. 1D is a closeup view of an exemplary radiator arm of the lowband dipole the first embodiment.

FIG. 2A illustrates an exemplary multiband array face incorporating a lowband dipole of a second embodiment according to the disclosure.

FIG. 2B illustrates a unit cell within the antenna of FIG. 2A.

FIG. 2C illustrates an exemplary lowband dipole according to a second embodiment according to the disclosure.

FIG. 2D is a closeup view of an exemplary radiator arm of a lowband dipole according to a second embodiment.

### DESCRIPTION OF EXEMPLARY EMBODIMENTS

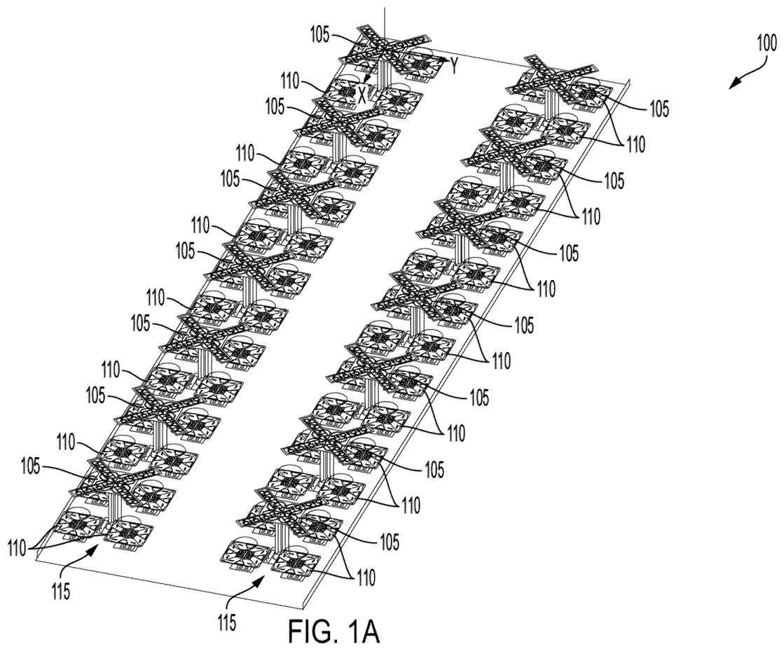

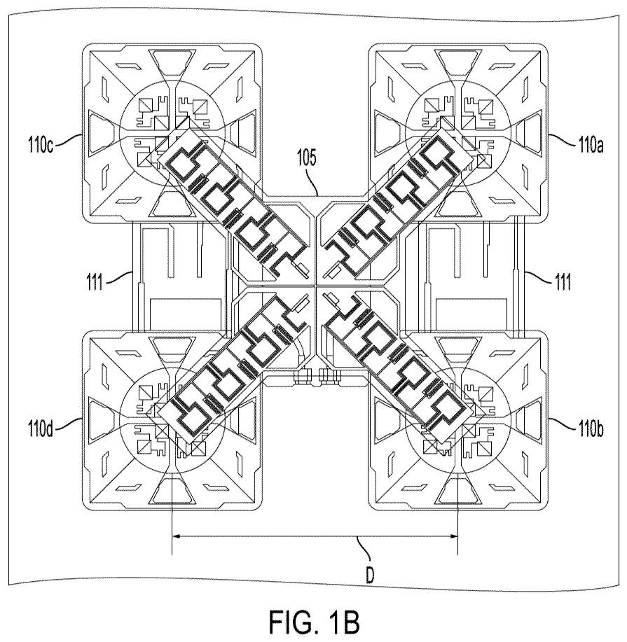

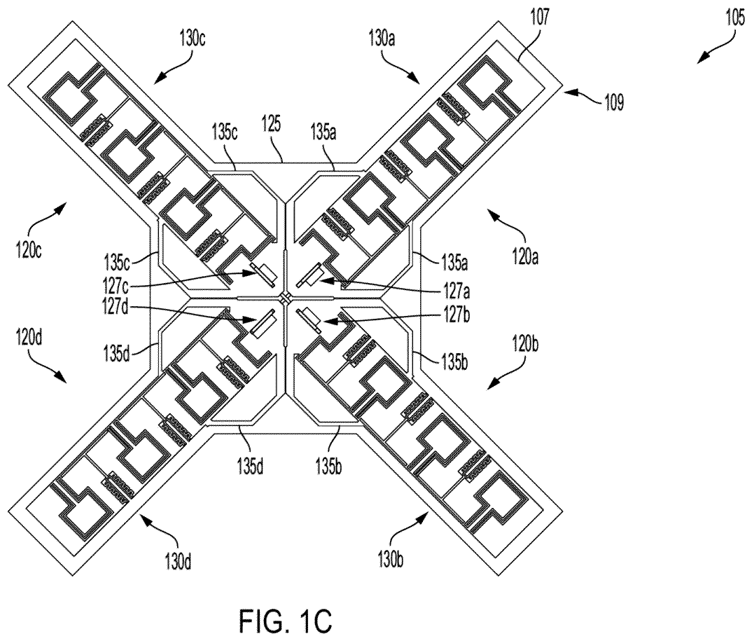

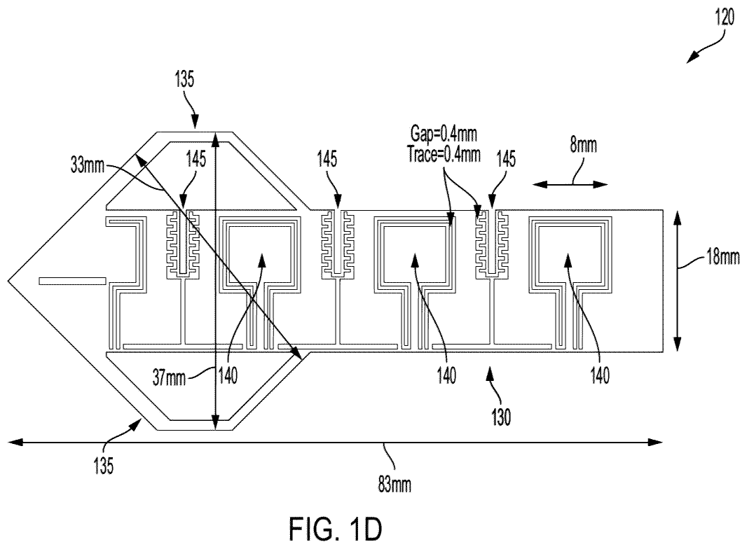

FIG. 1A illustrates an exemplary multiband array face 100 according to the disclosure. Array face 100 includes a plurality of lowband dipoles 105 and a plurality of midband dipoles 110. For the convenience of illustration, any additional frequency band radiators, such as C-Band or CBRS, are left out of the drawing. As illustrated, lowband radiators 105 are arranged in two columns 115 of unit cells having four midband dipoles 110 and a single lowband dipole 105.

Exemplary multiband array face 100 may be used in an antenna designed to have a 65 degree azimuth beamwidth.

FIG. 1B illustrates an exemplary unit cell of the antenna of FIG. 1. The unit cell has a single lowband dipole 105 that is placed among an array of four midband dipoles 110a-d. Midband dipoles 110a-d may have two independent and orthogonal radiators, each of which may be fed an independent signal so that two signals may operate at orthogonal (e.g., +/−45 deg) polarizations. Midband dipoles 110a and 110b may be fed two signals such that the +45 degree radiator of midband dipoles 110a and 110b may be fed a single signal that may have imparted on it a phase difference to enable beam pointing in the vertical plane. Similarly, midband dipoles 110a and 110b may be fed two signals such that the −45 degree radiator of midband dipoles 110a and 110b may be fed a single signal that may have imparted on it a phase difference to enable beam pointing in the vertical plane. The same applies to midband dipoles 110c and 110d.

There are two possible modes of feeding signals to midband dipoles 110a-d. In a first mode, midband dipoles 110a-d may all be provided the same signals (for both +/−45 deg polarizastion). Midband dipoles 110a/c may be provided these signals at a first phase offset and midband dipoles 110b /d may be provided the same signals but at a second phase offset. The differential phasing between midband dipoles 110a/c and 110b /d may be used to provide beam steering (tilt) in the vertical plane. This mode-with all the midband dipoles receiving the same signals) provides for an array effect such that the azimuth beam width may be controlled, based on lateral spacing D. In the example discussed here, the azimuth beamwidth may be 65 degrees.

In a second mode, midband dipoles 110a/b may be provided a first set of signals (one per +/−45 deg polarization) and midband dipoles may be provided a second set of signals (one per +/−45 deg polarization). This mode has a disadvantage of not having an array effect of the first mode, and as such the azimuth beamwidth in this mode will be broader. However, this mode offers an advantage of being able to handle twice as many signals in the midband. It will be understood that such variations are possible and within the scope of the disclosure.

The illustrated example in FIG. 1B shows two midband feedboards 111, which would be used in the second mode, in which a first set of signals (one per +/−45 degree polarization) is provided to midband dipoles 110a/b and a second set of signals (one per +/−45 degree polarization) is provided to midband dipoles 110c/d. It will be understood that a variation to the unit cell of FIG. 1B may have a single midband feedboard (not shown) in the case of a 65 degree azimuth beamwidth antenna.

In the case in which antenna 100 is designed to have a 65 degree azimuth beamwidth, lateral midband dipole spacing D may be approximately 114 mm.

Referring to FIG. 1B, lowband dipole 105 is placed within the cluster of four midband dipoles 110a-d. Lowband dipole 105 may be placed in the center of the cluster (as illustrated) or may be located at an offset in the horizontal and/or vertical directions. As can be observed in FIG. 1B, there is considerable shadowing of the midband dipoles 110a-d by the arms of lowband dipole 105, which may exacerbate interference between the lowband dipole 105 and the midband dipoles 110a-d. Narrowing the arms of lowband dipole 105 may reduce this interference, but this would also reduce the gain of lowband dipole 105. The structure of exemplary 105 dipole may be designed to strike a proper balance between high low band gain and mitigating interference, as described below.

FIG. 1C illustrates an exemplary lowband dipole 105 according to a first embodiment according to the disclosure. Lowband dipole 105 may be formed of a patterned conductive layer 107 that is disposed on a PCB (Printed Circuit Board) substrate 109. Lowband dipole 105 has four dipole arms 120a-d, whereby dipole arms 120a and 120d are colinear and are fed a first signal through a first balun circuit (not shown) via balun coupling points 127a and 127d that causes dipole arms 120a and 120d to radiate the first signal at a first (e.g., +45 deg) polarization orientation; and whereby dipole arms 120b and 120c are colinear and fed a second signal through a second balun circuit (not shown) via balun coupling points 127b and 127c that causes dipole arms 120b and 120c to radiate the second signal at a second (e.g., −45 deg) polarization orientation.

Lowband dipole 105 has a layout that includes four outer arms 130a-d, which are the outer portions of dipole arms 120a-d and jut out diagonally from a central region 125. In the case of dipole arm 120a, dipole arm 120a as an outer arm region 130a, whereby the conductive portion of dipole arm 120a extends from balun coupling point 127a within central region 125 out through outer arm region 130a. Dipole arm 120a also includes a set of high gain wings 135a, which may comprise conductive traces on either side of the arm structure within central region 125. Similarly, dipole arm 120b as an outer arm region 130b, whereby the conductive portion of dipole arm 120b extends from balun coupling point 127b within central region 125 out through outer arm region 130b. Dipole arm 120b also includes a set of high gain wings 135b, which may comprise conductive traces on either side of the arm structure within central region 125. The same applies to dipole arms 120c and 120d and their respective components.

The high gain wings 135a-d located in central region 125 improves gain by increasing the volume of lowband dipole 105 such that a larger portion of that volume is not overlapping the midband dipoles 110.

Each of dipole arms 120a-d has a conductive pattern that includes a series of capacitive and inductive structures, which are described below in reference to FIG. 1D.

The incorporation of high gain wings 135a-d provides additional gain to corresponding dipole arms 120a-d. The function of the high gain wings 135a-d may be as follows. As illustrated in FIG. 1B, lowband dipole 105 is in close proximity with four midband dipoles 110 such that the outer arm regions 130a-d substantially overlap with the midband dipoles 110. As mentioned above, it is possible to reduce interference by narrowing dipole arms 120a-d. However, as mentioned above, this reduces the lowband gain. Incorporating high gain wings 135a-d enables the outer arm regions 130a-d such that interference may be reduced, with the high gain wings 135a-d boosting the lowband gain of each lowband dipole 120a-d, thereby striking an appropriate balance between minimal interference and maximum gain. Further, given that the high gain wings 135a-d are disposed on central region of lowband dipole 105, the high gain wings 135a-d do not overlap the midband dipoles 110.

FIG. 1D illustrates an outer arm region 130 of a dipole arm 120 according to the disclosure, along with exemplary dimensions. The structure illustrated in FIG. 1D may be of any of the dipole arms 120a-d described above. Dipole arm 120 has an alternating plurality of capacitive structures 140 and inductive structures 145 that are formed in patterned conductive layer 107. Each inductive structure may have a high impedance line formed in the conductive layer 107. The spacing of the capacitive structure 140 and the inductive structure 145 is provided to make the dipole arm 120 transparent to any RF (Radio Frequency) emissions from the midband dipoles 110, whereas the capacitance and inductance of the respective capacitive structure 140 and inductive structure 145 allows the lowband RF energy to radiate in the dipole arm 120 unabated.

The size and spacing of capacitive structures 140 and inductive structures 145 may vary depending on the band of the dipole (e.g., midband, CBRS, etc.) that is in close proximity to the lowband dipole 105.

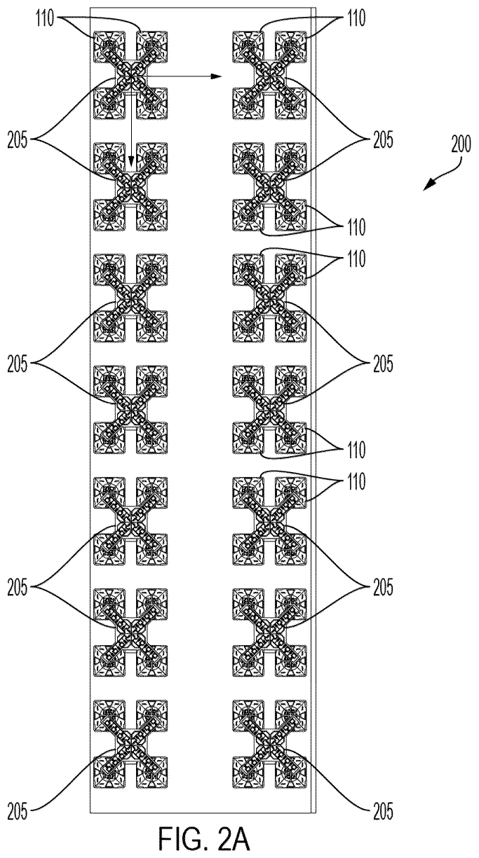

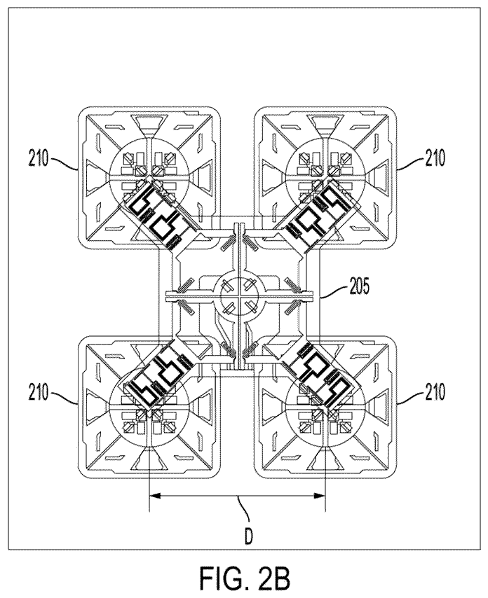

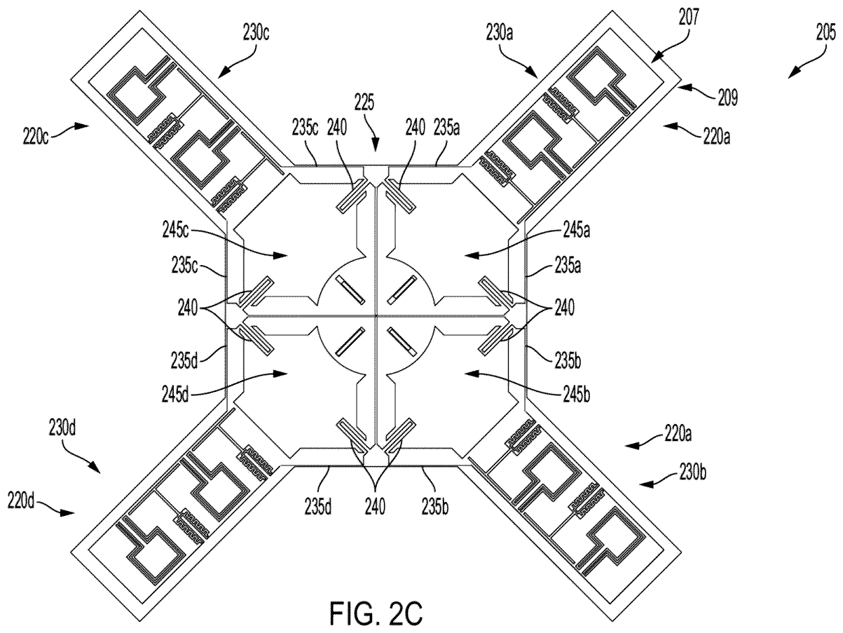

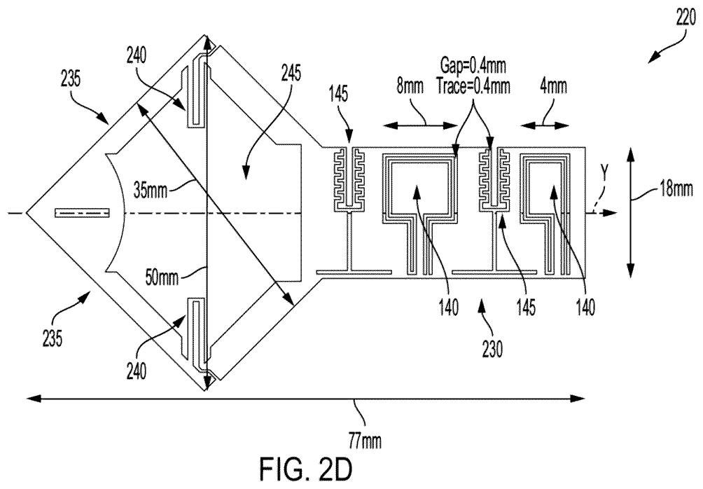

FIG. 2A illustrates an exemplary array face 200, which may be used for an antenna designed to have a 45 degree azimuth beamwidth. As with FIG. 1A, the radiators for other bands, such as C-Band or CBRS, are omitted for purposes of illustration. Array face 200 includes a plurality of lowband radiators 205 of a second embodiment of the disclosure. Each of the plurality of lowband radiators 205 are disposed within a cluster of four midband radiators 110, which may be identical to the midband radiators 110 of antenna array face 100.

FIG. 2B illustrates an exemplary unit cell for array face 200. As illustrated, a single lowband dipole 205 is disposed in the center of a cluster of four midband dipoles 110. However, in contrast to the unit cell of FIG. 1B, the midband dipoles for the 45 degree azimuth beam array face 200 are separated at a lateral spacing D of 90 mm. Having the midband dipoles 110 spaced more closely together in the proximity lowband dipole 205 exacerbates the interference problem in that if lowband dipole 105 were used in this unit cell, a greater proportion of lowband dipole 105 would overlap with the four midband dipoles 110. Accordingly, lowband dipole 205 may be used.

FIG. 2C illustrates exemplary lowband dipole 205 according to the disclosure. Lowband dipole 205 has a patterned conductive layer 207 that is disposed on a PCB substrate 209. Lowband dipole 205 has four dipole arms 220a-d, whereby dipole arms 220a and 220d are colinear and configured to radiate a first RF signal, and dipole arms 220b and 220c are colinear and configured to radiate a second RF signal. Each of the four dipole arms 220a-d has a corresponding outer arm region 230a-d that juts out from a central region 225 and. Dipole arms 220a-d are shorter than dipole arms 120a-d. This is to reduce the overlap of lowband dipole 205 over midband dipoles 110. To compensate for the shorter dipole arms 220a-d, the corresponding high gain wings 235a-d are increased in area and structure, thereby increasing the volume of lowband dipole 205 to increase gain. Another feature of lowband dipole 205 is that each dipole arm 220a-d has a gap 245a-d, which provides a clear space in the conductive layer 207 that is colinear with its corresponding outer arm region 230a-d. This has the effect of eliminating some of the overlap of dipole arms 230a-d and the midband dipoles 110, and thereby reducing the interference. Each of the high gain wings 235a-d of dipole arms 230a-d has an inductive choke 240 disposed at a corner of the high gain wing 235a-d that provides further cloaking to prevent midband RF energy radiating from midband dipoles 110 from resonating in the high gain wings 235a-d, rendering the high gain wings transparent to the midband dipoles 110. Each of the dipole arms 230a-d has an alternating sequence of inductive structures and capacitive structures that may be similar to those illustrated in FIG. 1D.

FIG. 2D illustrates an exemplary dipole arm 220 according to the disclosure, along with exemplary dimensions. Dipole arm 220 of FIG. 2D has variations to the dipole arms 220a-d illustrated in FIG. 1C. It will be understood that such variations are possible and within the scope of the disclosure. Referring to FIG. 2D, dipole arm 220 has an outer arm region 230 and two high gain wings 235, each of which having an inductive choke 240 disposed at a corner. Outer arm region 230 has a plurality of capacitive structures 140 and inductive structures 145 that are arranged in an alternating sequence. Dipole arm 220 has a gap 245 formed in the conductor, whereby gap 245 is substantially colinear with outer arm region 230.

1. (canceled)

2. A dipole for a multiband antenna having four dipole arms arranged in a cross pattern, each of the dipole arms comprising:
an outer arm region having alternating inductive regions and capacitive regions; and
two high gain wings disposed at an inner end of the outer region, the two high gain wings defining a gap that is colinear with the outer arm region and having, each of the two high gain wings having a corner on which is disposed an inductive choke.

3. The dipole of claim 1, wherein the outer arm comprises:
a first inductive structure closest to the high gain wings;
a first capacitive structure adjacent to the first inductive structure;
a second inductive structure adjacent to the first capacitive structure; and
a second capacitive structure adjacent to the second inductive structure.

4. The dipole of claim 2, wherein the first capacitive structure comprises a width of 8 mm.

5. The dipole of claim 3, wherein the second capacitive structure comprises a width of 4 mm.

6. The dipole of claim 2, wherein the first inductive structure, the first capacitive structure, the second inductive structure, and the second capacitive structure, each comprise:
a trace that comprises a trace width of 0.4 mm; and
a trace gap that comprises a gap width of 0.4 mm.

7. The dipole of claim 1, wherein each dipole arm comprises a lengh of 77 mm.

8. The dipole of claim 6, wherein each outer arm region comprises a width of 18 mm.

9. The dipole of claim 1, wherein each dipole arm comprises a conductive layer that is disposed on a PCB (Printed Circuit Board) substrate.
